(19) United States
(12) Patent Application Publication
(10) Pub. No.: US 2026/0270749 A1
(43) Pub. Date: Sep. 10, 2026

(54) NON-PUBLIC NETWORK (NPN) ID CHECK TO DELETE THE SON REPORTS AT THE USER EQUIPMENT

(71) Applicant: Telefonaktiebolaget LM Ericsson (publ), Stockholm (SE)

(72) Inventors: Tahmineh Torabian Esfahani, Sollentuna (SE); Ali Parichehrehteroujeni, Linköping (SE)

(21) Appl. No.: 19/115,271

(22) PCT Filed: Oct. 13, 2023
(86) PCT No.: PCT/IB2023/060368

§ 371 Date: Mar. 26, 2025

Related U.S. Application Data
(60) Provisional application No. 63/416,203, filed on Oct. 14, 2022.

(51) Int. Cl. H04W 24/10

(52) U.S. Cl. CPC H04W 24/10

(57) ABSTRACT

Systems and methods are disclosed that relate Self-Organizing Network (SON)/Minimization of Driving Testing (MDT) measurement and information reporting. In one embodiment, a method performed by a User Equipment (UE) comprises connecting or registering to a first network and, while connected or registered to the first network, storing SON/MDT measurements and information. The method further comprises connecting or registering to a second network and disconnecting or deregistering from the first network while having un-fetched SON/MDT measurements and information for the first network stored in the UE. The method further comprises performing one or more actions to ensure that the un-fetched SON/MDT measurements and information for the first network are not mixed with SON/MDT measurements and information for the second network. In this manner, the UE avoids logging SON/MDT information of the two networks together in the same report/variable.

### RELATED APPLICATIONS

This application claims the benefit of provisional patent application Ser. No. 63/416,203, filed Oct. 14, 2022, the disclosure of which is hereby incorporated herein by reference in its entirety.

### TECHNICAL FIELD

The present disclosure relates to a cellular communications system and, more specifically, Self-Organizing Network (SON)/Minimization of Drive Testing (MDT) reporting in a cellular communications system.

### BACKGROUND

A Non-Public Network (NPN) is a 5^{th} Generation System (5GS) deployed for non-public use. An NPN is either:
a Stand-alone Non-Public Network (SNPN), i.e., operated by an NPN operator and not relying on network functions provided by a Public Land Mobile Network (PLMN), or
a Public Network Integrated NPN (PNI-NPN), i.e., a non-public network deployed with the support of a PLMN.
   An NPN and a PLMN can share a Next Generation Radio Access Network (NG-RAN) as described in clause 5.18 in 3^{rd} Generation Partnership Project (3GPP) Technical Specification (TS) 23.501 (see, e.g., V17.5.0).

### Stand-Alone Non-Public Networks

The combination of a PLMN Identifier (ID) and Network Identifier (NID) identifies an SNPN. NIDs are either:
chosen individually by SNPNs at deployment time (and may therefore not be unique) but use a different numbering space than the coordinated assignment; or
chosen in a coordinated manner and are therefore globally unique independent of the PLMN ID used; or
globally unique only in combination with the PLMN ID.

NG-RAN nodes which provide access to SNPNs broadcast the following information:
One or multiple PLMN IDs;
List of NIDs per PLMN ID identifying the non-public networks to which the NG-RAN provides access; and
Optionally:
   A human-readable network name per SNPN;
   Information to prevent User Equipments (UEs) not supporting SNPNs from accessing the cell, e.g., if the cell only provides access to non-public networks.

An SNPN-enabled UE supports the SNPN access mode. When the UE is set to operate in SNPN access mode, the UE only selects and registers with SNPNs over Uu.

UEs operating in SNPN access mode only select cells and networks broadcasting both PLMN ID and NID of the selected SNPN.

If the UE moves its 3GPP access between SNPN and PLMN, network selection is performed, and the UE performs initial registration. If the UE moves its 3GPP access between SNPNs, network selection is performed, then the UE performs initial or mobility registration.

### Public Network Integrated NPN

Public Network Integrated NPNs (PNI-NPNs) are NPNs made available via PLMNs. When a PNI-NPN is made available via a PLMN, then the UE shall have a subscription for the PLMN in order to access PNI-NPN.

A Closed Access Group (CAG) identifies a group of subscribers who are permitted to access one or more CAG cells associated to the CAG. CAG is used for the PNI-NPNs to prevent UE(s), which are not allowed to access the NPN via the associated cell(s), from automatically selecting and accessing the associated CAG cell(s).

The following is required for identification:
A CAG is identified by a CAG Identifier which is unique within the scope of a PLMN ID;
A CAG cell broadcasts one or multiple CAG Identifiers per PLMN;
A CAG cell may in addition broadcast a human-readable network name per CAG Identifier:

To use CAG, the UE that supports CAG as indicated as part of the UE 5G Mobility Management (5GMM) Core Network Capability may be pre-configured or (re)configured with the following CAG information, which is included in the subscription as part of the Mobility Restrictions:
an Allowed CAG list i.e., a list of CAG Identifiers the UE is allowed to access; and
optionally, a CAG-only indication that indicates whether the UE is only allowed to access 5GS via CAG cells (see 3GPP TS 38.304 V17.1.0 for how the UE identifies whether a cell is a CAG cell).

In a PLMN, the UE shall only consider the CAG information provided for this PLMN.

When the UE is roaming and the Serving PLMN provides CAG information, the UE shall update only the CAG information provided for the Serving PLMN while the stored CAG information for other PLMNs are not updated. When the UE is not roaming and the Home PLMN (HPLMN) provides CAG information, the UE shall update the CAG information stored in the UE with the received CAG information for all the PLMNs.

The UE shall store the latest available CAG information for every PLMN for which it is provided and keep it stored when the UE is de-registered or switched off.

The following is assumed for network and cell selection and access control:
The CAG cell shall broadcast information such that only UEs supporting CAG are accessing the cell (see 3GPP TS 38.300V17.1.0 , 3GPP TS 38.304V17.1.0 );
The Mobility Restrictions shall be able to restrict the UE's mobility according to the Allowed CAG list (if configured in the subscription) and include an indication of whether the UE is only allowed to access 5GS via CAG cells (if configured in the subscription) as described in clause 5.30.3.3 in 3GPP TS 23.501V17.5.0;

Emergency Services are supported in CAG cells, for UEs supporting CAG, whether normally registered or emergency registered.

Radio Access Network (RAN) sharing supports the following sharing scenarios involving non-public networks, i.e. NG-RAN can be shared by any combination of PLMNs, PNI-NPNs (with CAG), and SNPNs (each identified by PLMN ID and NID).

In all non-public network sharing scenarios, each Cell Identity is associated with one of the following configuration options:
one or multiple SNPNs;
one or multiple PNI-NPNs (with CAG); or
one or multiple PLMNs only.

The content of cell access related has to follow the specified RAN sharing restrictions.

In general, a UE is successfully registered on a private network/NPN if (1) the UE has found a suitable NPN cell to camp on and (2) a location request from the UE has been accepted in the registration area of the cell on which the UE is camped. The UE may have access and subscription profile to several networks/different network types (SNPN, PNI-NPNs and PLMNs) and will perform registration on the private network/NPN e.g., SNPN if the UE is capable of services which require registration. Network selection is performed as follows:
IDLE/INACTIVE mode mobility in NPN
   PNI-NPN:

A PNI-NPN cell is considered suitable if the broadcasted CAG ID is included in the CAG ID information list (as provided to the UE from the 5G Core (5GC)) or if it is a public cell and the UE is not configured with the “CAG only” indication. Upon request from the Non-Access Stratum (NAS), the Access Stratum (AS) layer shall scan its supported frequencies and report the available PNI-NPNs (identified by PLMN ID+CAG ID) to NAS which selects the network to use.
SNPN:

The cell selection/re-selection shall only occur within that SNPN, i.e., a cell is only considered suitable if the broadcasted SNPN identifier matches the selected SNPN. This is similar to how normal cell selection/re-selection works when the UE has selected a PLMN.

Upon request from NAS, the AS layer searches for SNPN cells, and, if an SNPN cell is found, the SNPN identifier is reported to the NAS layer which does the network selection.
Connected mode mobility in NPN

Connected mode mobility for UEs operating in NPN is similar to regular legacy mobility. A gNodeB (gNB) receives the allowed networks in the Mobility Restrictions List (MRL) in 3GPP TS 38.413 V17.1.1 such that the gNB knows what are allowable as candidate cells:
PNI-NPN:

The Allowed PNI-NPN List is provided to the serving RAN node by the 5GC as part of MRL, hence the serving RAN node(s) can restrict the UEs connected mode mobility according to the UE's allowed PNI-NPNs. In addition, the mobility procedures can be performed between PNI-NPN and the public network, see FIG. 1.
SNPN:

Up to 3GPP Release 17, only a single serving SNPN ID is provided within the MRL, as there is no mobility specified between SNPNs or between an SNPN and a PLMN. Hence, neighbor SNPN cells of different SNPNs or neighboring cells of a PLMN are not selected as candidate cells for inter network mobility between if the UE is registered in an SNPN. Re-registration is currently the only option to change between a PLMN and SNPN.

FIG. 2 illustrates an SNPN versus public network.

The cross-network mobility considering frequency deployments for NPN cells are not fully clear. In general, NPN and PN cells can be deployed with different frequency configurations:
1. Inter-frequency configuration: NPN cells are operating on different frequencies among their neighbor cells.
2. Intra-frequency configuration: A frequency band might be shared between two different networks (NPN↔PN).

The following are relevant excerpts from 3GPP TS 38.331V17.1.0:

### Start Excerpts from TS 38.331

### 5.7.10.4 Actions Upon Successful Completion of a Random-Access Procedure or on Completion of a Request of On-Demand System Information

Upon successfully performing random-access procedure initialized with 4-step or 2-step RA type, or upon failed or successfully completed on-demand system information acquisition procedure in RRC_IDLE or RRC_INACTIVE state, the UE shall:
1> if the RPLMN or the PLMN selected by upper layers (see TS 24.501 [23 ]) from the PLMN(s) included in the plmn-IdentityList in SIB1 is not included in plmn-IdentityList stored in a non-empty VarRA-Report:
   2> clear the information included in VarRA-Report,
1> . . .

### Next Excerpt from TS 38.331

### 5.3.5.3 Reception of an RRCReconfiguration by the UE

The UE shall perform the following actions upon reception of the RRCReconfiguration, or upon execution of the conditional reconfiguration (CHO, CPA or CPC):
1> set the content of the RRCReconfigurationComplete message as follows:
   2> if the RRCReconfiguration includes the masterCellGroup containing the reportUplink TxDirectCurrent:
      3> include the uplink TxDirectCurrentList for each MCG serving cell with UL;
      3> include uplinkDirectCurrentBWP-SUL for each MCG serving cell configured with SUL carrier, if any, within the uplinkTxDirectCurrentList,
   2> if the RRCReconfiguration includes the masterCellGroup containing the reportUplink TxDirectCurrentTwoCarrier:
      3> include in the uplink TxDirectCurrentTwoCarrierList the list of uplink Tx DC locations for the configured intra-band uplink carrier aggregation in the MCG;
   2> if the RRCReconfiguration includes the secondaryCellGroup containing the reportUplink TxDirectCurrent:
      3> include the uplink TxDirectCurrentList for each SCG serving cell with UL;
      3> include uplinkDirectCurrentBWP-SUL for each SCG serving cell configured with SUL carrier, if any, within the uplinkTxDirectCurrentList,
   2> if the RRCReconfiguration includes the secondaryCellGroup containing the reportUplink TxDirectCurrentTwoCarrier:
      3> include in the uplink TxDirectCurrentTwoCarrierList the list of uplink Tx DC locations for the configured intra-band uplink carrier aggregation in the SCG;

NOTE 0b: It is expected that the reportUplinkTxDirectCurrentTwoCarrier is only received either in masterCellGroup or in secondaryCellGroup but not both.
2> if the RRCReconfiguration message includes the mrdc-SecondaryCellGroupConfig with mrdc-SecondaryCellGroup set to eutra-SCG:
   3> include in the eutra-SCG-Response the E-UTRA RRCConnectionReconfigurationComplete message in accordance with TS 36.331 [10] clause 5.3.5.3;
2> if the RRCReconfiguration message includes the mrdc-Secondary CellGroupConfig with mrdc-SecondaryCellGroup set to nr-SCG:
   3> include in the nr-SCG-Response the SCG RRCReconfigurationComplete message;
   3> if the RRCReconfiguration message is applied due to conditional reconfiguration execution and the RRCReconfiguration message does not include the reconfiguration WithSync in the masterCellGroup:
      4> include in the selectedCondRRCReconfig the condReconfigId for the selected cell of conditional reconfiguration execution;

2> if the RRCReconfiguration includes the reconfigurationWithSync in spCellConfig of an MCG:

3> if the UE has logged measurements available for NR and if the RPLMN is included in plmn-IdentityList stored in VarLogMeasReport:
4> include the logMeasAvailable in the RRCReconfigurationComplete message;
4> if Bluetooth measurement results are included in the logged measurements the UE has available for NR:
5> include the logMeasAvailableBT in the RRCReconfigurationComplete message;
   4> if WLAN measurement results are included in the logged measurements the UE has available for NR:
5> include the logMeasAvailable WLAN in the RRCReconfigurationComplete message;
   3> if the sigLoggedMeasType in VarLogMeasReport is included:
      4> if T330 timer is running and the logged measurements configuration is for NR:
5> set sigLogMeasConfigAvailable to true in the RRCReconfigurationComplete message;
   4> else:
5> if the UE has logged measurements available for NR:
6> set sigLogMeasConfigAvailable to false in the RRCReconfigurationComplete message;
   3> if the UE has connection establishment failure or connection resume failure information available in VarConnEstFailReport or VarConnEstFailReportList and if the RPLMN is equal to plmn-Identity stored in VarConnEstFailReport or VarConnEstFailReportList:
      4> include connEstFailInfoAvailable in the RRCReconfigurationComplete message;
   3> if the UE has radio link failure or handover failure information available in VarRLF-Report and if the RPLMN is included in plmn-IdentityList stored in VarRLF-Report; or
   3> if the UE has radio link failure or handover failure information available in VarRLF-Report of TS 36.331 [10] and if the UE is capable of cross-RAT RLF reporting and if the RPLMN is included in plmn-IdentityList stored in VarRLF-Report of TS 36.331 [10]:
      4> include rif-InfoAvailable in the RRCReconfigurationComplete message;
   3> if the UE was configured with successHO-Config when connected to the source PCell; and
   3> if the applied RRCReconfiguration is not due to a conditional reconfiguration execution upon cell selection performed while timer T311 was running, as defined in 5.3.7.3:
      4> perform the actions for the successful handover report determination as specified in clause 5.7.10.6, upon successfully completing the Random Access procedure triggered for the reconfigurationWithSync in spCellConfig of the MCG;
   3> if the UE has successful handover information available in VarSuccessHO-Report and if the RPLMN is included in plmn-IdentityList stored in VarSuccessHO-Report:
      4> include successHO-InfoAvailable in the RRCReconfigurationComplete message;

2> if the RRCReconfiguration message was received via SRB1, but not within mrdc-SecondaryCellGroup or E-UTRA RRCConnectionReconfiguration or E-UTRA RRCConnectionResume:

### End Excerpts from TS 38.331

### SUMMARY

Systems and methods are disclosed that relate Self-Organizing Network (SON)/Minimization of Driving Testing (MDT) measurement and information reporting. In one embodiment, a method performed by a User Equipment (UE) comprises connecting or registering to a first network and, while connected or registered to the first network, storing SON/MDT measurements and information. The method further comprises connecting or registering to a second network and disconnecting or deregistering from the first network while having un-fetched SON/MDT measurements and information for the first network stored in the UE. The method further comprises performing one or more actions to ensure that the un-fetched SON/MDT measurements and information for the first network are not mixed with SON/MDT measurements and information for the second network. In this manner, the UE avoids logging SON/MDT information of the two networks (e.g., either one Public Network (PN) and one Non-Public Network (NPN) or two NPNs) together in the same report/variable even if the two networks have the same Public Land Mobile Network (PLMN) identity.

In one embodiment, the first network and the second network are independent networks.

In one embodiment, the first network is a public network, and the second network is a NPN.

In one embodiment, the first network is a public network, and the second network is a Standalone Non-Public Network (SNPN) or Public Network Integrated Non-Public Network (PNI-NPN).

In one embodiment, performing the one or more actions to ensure that the un-fetched SON/MDT measurements and information for the first network are not mixed with SON/MDT measurements and information for the second network comprises performing the one or more actions to ensure that the un-fetched SON/MDT measurements and information for the first network are not mixed with SON/MDT measurements and information for the second network even if the first network and the second network have a same PLMN Identity (ID).

In one embodiment, performing the one or more actions to ensure that the un-fetched SON/MDT measurements and information for the first network are not mixed with SON/MDT measurements and information for the second network comprises determining that a network identity of the second network is different than a network identity of the first network and, in response thereto, deleting the un-fetched SON/MDT measurements and information for the first network and storing new SON/MDT measurements and information for the second network. In one embodiment, deleting the un-fetched SON/MDT measurements and information for the first network comprises deleting the un-fetched SON/MDT measurements and information for the first network from one or more UE variables, and storing the new SON/MDT measurements and information for the second network comprises storing new SON/MDT measurements and information for the second network in the same one or more UE variables. In one embodiment, the network identity of the second network is a NPN identifier and the network identity of the first network node is either a PLMN identifier or a combination of a PLMN identifier and a NPN identifier. In one embodiment, determining that the network identity of the second network is different than the network identity of the first network comprises determining that the network identity of the second network is different than the network identity in response to either logging a SON/MDT report that pertains to the second network or registering to the second network.

In one embodiment, performing the one or more actions to ensure that the un-fetched SON/MDT measurements and information for the first network are not mixed with SON/MDT measurements and information for the second network comprises storing SON/MDT measurements and information for the second network in association with a network identity of the second network. In one embodiment, storing the SON/MDT measurements and information for the first network comprises storing the SON/MDT measurements and information for the first network in one or more UE variables, and storing the SON/MDT measurements and information for the second network in association with the network identity of the second network comprises storing the SON/MDT measurements and information for the second network in association with the network identity of the second network in the same one or more UE variables. In one embodiment, the network identity of the second network is either a NPN identifier or a SNPN identifier. In one embodiment, the method further comprises deleting the un-fetched SON/MDT measurements and information for the first network after a certain amount of time.

In one embodiment, the method further comprises sending, to a network node in the second network, a reports comprising SON/MDT measurements and information for the second network.

Corresponding embodiments of a UE are also disclosed. In one embodiment, a UE is adapted to connect or register to a first network and, while connected or registered to the first network, store SON/MDT measurements and information. The UE is further adapted to connect or register to a second network and disconnect or deregister from the first network while having un-fetched SON/MDT measurements and information for the first network stored in the UE. The UE is further adapted to perform one or more actions to ensure that the un-fetched SON/MDT measurements and information for the first network are not mixed with SON/MDT measurements and information for the second network.

In one embodiment, a UE comprises a communication interface and processing circuitry associated with the communication interface. The processing circuitry is configured to cause the UE to connect or register to a first network and, while connected or registered to the first network, store SON/MDT measurements and information. The processing circuitry is further configured to cause the UE to connect or register to a second network and disconnect or deregister from the first network while having un-fetched SON/MDT measurements and information for the first network stored in the UE. The processing circuitry is further configured to cause the UE to perform one or more actions to ensure that the un-fetched SON/MDT measurements and information for the first network are not mixed with SON/MDT measurements and information for the second network.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of a mobility procedure performed between a Public Network Integrated Non-Public Network (PNI-NPN) and the public network;

FIG. 2 illustrates a Standalone Non-Public Network (SNPN) versus a public network;

FIG. 3 illustrates a method performed by a User Equipment (UE) in accordance with one example embodiment of the present disclosure;

FIG. 4 shows an example of a communication system in accordance with some embodiments;

FIG. 5 shows a UE in accordance with some embodiments;

FIG. 6 shows a network node in accordance with some embodiments;

FIG. 7 is a block diagram of a host, which may be an embodiment of the host of FIG. 4, in accordance with various aspects described herein;

FIG. 8 is a block diagram illustrating a virtualization environment in which functions implemented by some embodiments may be virtualized; and

FIG. 9 shows a communication diagram of a host communicating via a network node with a UE over a partially wireless connection in accordance with some embodiments.

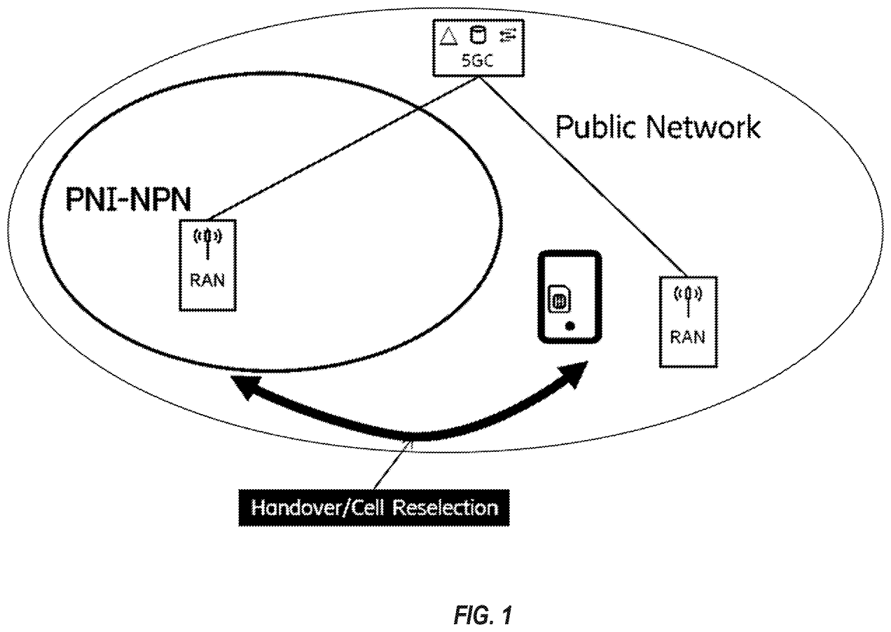

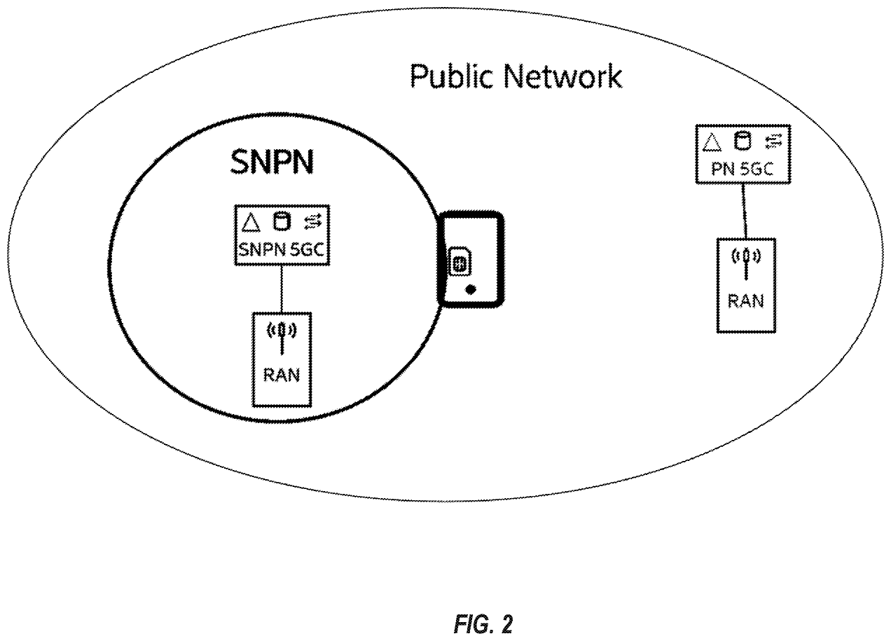

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). In general, in case a User Equipment (UE) holds subscriptions of both one or several Standalone Non-Public Networks (SNPNs) and one or several Public Land Mobile Networks (PLMNs), the UE may switch to the proper access mode (the access mode selection is up to the UE implementation). The UE can choose to perform either SNPN network selection or PLMN selection. Moreover, the UE that is not set to operate in SNPN access mode cannot perform SNPN network selection, rather it can only perform network selection among PLMNs.

On the basis of 3^{rd} Generation Partnership Project (3GPP) Technical Specification (TS) 38.331 V17.1.0 , the UE logs Self-Organizing Network (SON) report (for example Random Access (RA) Report) in a single variable. This leads to a situation where the UE may log SON/Minimization of Drive Testing (MDT) data for both a first network (e.g., a Public Network (PN)) and a second network (e.g., SNPN) in the same variable. The second network, e.g. SNPN, as an independent network would not be able to collect SON/MDT logged information without having impact from the first network e.g., PN. The UE may store a mix of the first and second network data particularly when the NPN network (e.g., an SNPN) broadcasts the same PLMN identity as the public network (e.g., PLMN) (i.e., when the only distinguishing part of the PN and SNPN identity relies on the Non-Public Network (NPN) identifier e.g., NID). In other words, if the PLMN identity of the PN and that of the NPN (here an SNPN) is the same, the UE may log a blended set of up to 8 RA reports collected from SNPN and PN, which is not the expected behavior. Furthermore, the UE may delete the logged SON/MDT data upon network reselection. In this case, although the UE is changing its access mode temporarily, the UE would discard a previously stored SON/MDT reports collected from the previous network e.g., the UE discards the collected reports while in the PN, upon registering to SNPN. Moreover, the SON/MDT related information associated to the old network is lost.

Certain aspects of the disclosure and their embodiments may provide solutions to these or other challenges. Systems and methods are disclosed herein that provide a solution(s) performed by the wireless terminal, so-called User Equipment (UE) capable of mobility between a PN and an NPN, to prevent SON/MDT data(s) loss via one or more of the following:
1) The UE has subscription to multiple networks. This can be a combination of public networks, Public Network Integrated NPN (PNI-NPN) networks, and SNPN networks.
2) The UE has logged SON/MDT related information in UE variable(s) that are not yet fetched by the first network e.g., PN.
3) The UE is registered to the second network e.g., SNPN and consequently it will be deregistered from the first network e.g., PN.
4) The UE is subjected to a new event for which the SON/MDT related information is logged in the same UE variables. In this case, the UE checks the network identity before logging the new data associated to the new network (the second network e.g., SNPN).
5) The UE logs the new logged SON/MDT collected data(s) with associated network identity e.g., npn-identityInfo (SNPN ID) inclusion. With this, the UE shares the associated UE variables with new network temporarily without UE memory extension before deleting the old collected data. The UE isolates the new collected information associated for the new registered network e.g., SNPN. Moreover, the UE ensures no loss of information by storing the new collected SON/MDT data in the second network e.g., SNPN.
6) UE performs PLMN/NPN identity check before reporting the report to the associated network.
7) The UE sends the report(s) generated for the second network while in the second network (associated to the serving network, e.g., RA report to the serving network.
8) The UE deletes the old network SON/MDT data after a certain time.

The reports may be signaled to the first network and then forwarded from the first network to the second network.

The reports may be signaled to the second network upon connection by the UE to the second network.

Systems and methods are disclosed herein that allow the UE to log SON/MDT data from different networks with different network types (e.g., PN and NPN) as per received SON/MDT configuration from the Operations, Administration, and Maintenance (OAM) or from a network node.

In one embodiment, the UE checks the NPN identifier of the second network node (e.g., NID of the SNPN or Cell Access Group (CAG) of a PNI-NPN) either:
when moving from first network to the second network, or
when logging a SON report for the second network node,
   to make sure that the SON report of the first network is not mixed/blended with the second network and vice versa.

In one embodiment, upon determining that the NPN identifier (e.g., NID of the SNPN or CAG of a PNI-NPN) of the second network is different from the network identity (either only PLMN(s) is stored, or PLMN(s) plus NPN identifier such as NID or CAG) stored at the UE variables associated to the SON reports, the UE deletes the SON reports before storing the new SON reports for the second network.

Certain embodiments may provide one or more of the following technical advantage(s). Embodiments of the present disclosure may enable the UE to avoid logging SON/MDT information of the two independent networks (either one PN and one NPN or two NPNs) together in the same report/variable even if the two networks have the same PLMN identity. With this mechanism, isolating the SON/MDT measurements for two networks is assured, and the risk of exposing information and measurements from one network to another network will be lowered.

Moreover, the SON reports related to different networks such as NPN/PN networks are not lost. Moreover, in case where multiple reports are generated for different types of networks, the UE stores the reports on a per type of network basis without UE memory extension, so that the reports are retrievable by the network.

Systems and methods are disclosed herein that relate to a wireless terminal, so-called UE, that is capable of mobility between PN and NPN or accessing both PN and NPN or multiple NPNs.

A UE in a first network (e.g., a PN) may collect SON/MDT data(s) (which is not yet fetched by the network) and moves from the first network (e.g., PN) to a second network (e.g., SNPN) which leads the UE to collect additional SON/MDT data for the second network (e.g., SNPN) as an independent network.

In one embodiment, the UE continues logging SON/MDT data(s) for the second network (e.g., SNPN) in the same variable(s) without UE memory extension. The allocated memory for the UE variable can be divided and isolated between two independent networks temporarily. This can be done with extra information about the network identity (e.g., SNPN ID) tagged to the new allocated space for collected data associated to the second network (e.g., SNPN). With this, the UE shares the associated UE variables with the second network (e.g., SNPN) temporarily before deleting the old collected data. The UE isolates the new collected information associated to the new registered network (e.g., SNPN). Moreover, the UE ensures no loss of latest information associated by the second network (e.g., SNPN) by storing the new collected SON/MDT data in the same variable. In addition, the UE is able to report the associated logged SON/MDT related information to a network wherein the event that triggered the report occurred.

The assumption for the UE performing the following method is that the UE has subscription to multiple networks. This can be any combination of public networks, PNI-NPN networks, and SNPN networks.

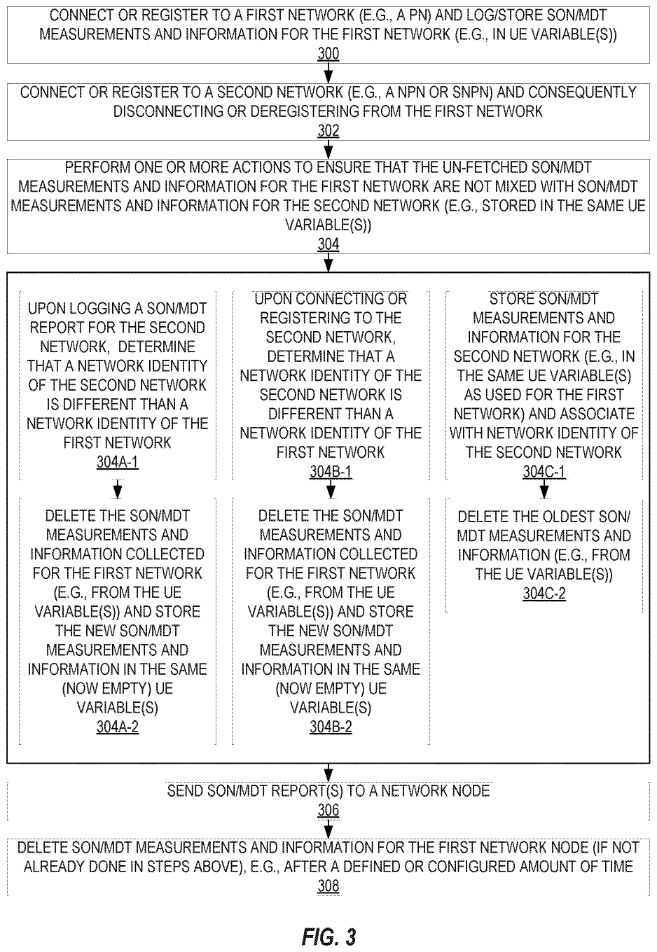

FIG. 3 illustrates a method performed by a UE in accordance with one example embodiment of the present disclosure. Note that optional steps are indicated by dashed lines/boxes.

Step 300: A UE is connected or registered to a first network (e.g., a PN) and logs and stores SON and/or MDT (i.e., SON/MDT) measurements and information, e.g., in one or more UE variable(s) that are not fetched by the first network before the UE moves to a second network (see step 302).

Step 302: The UE is subsequently registered to a second network (e.g., SNPN).

Consequently, the UE is deregistered from the first network (e.g., PN) while having un-fetched SON/MDT measurement and information collected in the first network and, e.g., stored in the one or more UE variable(s).

Step 304: The UE performs one or more actions to ensure that the un-fetched SON/MDT measurements and information for the first network (e.g., stored in the one or more UE variables) are not mixed with SON/MDT measurements and information collected for the second network (and, e.g., stored in the same one or more UE variables). In one embodiment, this is done even if the first and second networks have the same PLMN ID.

In one embodiment of step 304, the UE is subjected to a new event for which the SON/MDT related information is logged in the same UE variables. In this case, the UE checks whether the network identity (e.g., PLMN or PLMN+NID/SNPN ID) matches with the network that the UE is registered to before logging the new data associated to the new network (the second network e.g., SNPN).
In an embodiment, upon logging a SON/MDT report (measurements and information) pertaining to the second network, the UE determines whether the NPN identifier(s) (e.g., NID or a list of NIDs) of the second network (SNPN) is/are the different from the identifier(s) of the first network (the identifier(s) of the first network can be either a PLMN or a PLMN plus NPN identifier(s) such as NID(s) or CAG(s)) (step 304A-1). If the UE determines that the NPN identifier(s) (e.g., NID or a list of NIDs) of the second network (SNPN) is/are the different from the identifier(s) of the first network (the identifier(s) of the first network can be either a PLMN or a PLMN plus NPN identifier(s) such as NID(s) or CAG(s)), the UE deletes the SON/MDT report(s) collected for the first network from the UE variable(s) and stores the new SON/MDT report in the empty variable (steps 304A-2 and 304A-3).
In another embodiment, upon registering to the second network, the UE determines whether the NPN identifier(s) (e.g., NID or a list of NIDs) of the second network (SNPN) is/are the different from the identifier(s) of the first network (the identifier(s) of the first network can be either a PLMN or a PLMN plus NPN identifier(s) such as NID(s) or CAG(s)) (304B-1). If the UE determines that the NPN identifier(s) (e.g., NID or a list of NIDs) of the second network (SNPN) is/are the different from the identifier(s) of the first network (the identifier(s) of the first network can be either a PLMN or a PLMN plus NPN identifier(s) such as NID(s) or CAG(s)), the UE deletes the SON/MDT report(s) collected for the first network from the UE variable(s) and store the new reports in the empty variable (steps 304B-2 and 304B-3).

In another embodiment, the UE logs the new logged SON/MDT collected data(s) with associated network identity e.g., npn-identityInfo (SNPN ID) inclusion (step 304C-1). With this, the UE shares the associated UE variables with new network temporarily without UE memory extension before deleting the old collected data. The UE isolates the new collected information associated for the new registered network e.g., SNPN. Moreover, the UE ensures no loss of information by storing the new collected SON/MDT data in the second network e.g., SNPN.
In one embodiment, the UE deletes (304C-2) the oldest collected data in the UE variable in order to make room for new SON/MDT data.

UE performs PLMN/NPN identity check before reporting the report to the associated network.

Step 306: In another embodiment, the UE sends the report(s) generated for the second network while in the second network e.g., SNPN (associated to the serving network, e.g., RA report to the serving network).

Step 308: In another embodiment, if not already done in a preceding step, the UE deletes the old network SON/MDT data(s) after a certain time.
In another embodiment, the time value for keeping the old network data(s) can be configured by the first network e.g., PN.
In yet another embodiment, the time value can be set by the UE itself.

In yet another embodiment, the reports may be signaled to the first network and then forwarded from the first to the second network.

In another embodiment, the reports may be signaled to the second network, upon connection by the UE to the second network.

A non-limiting example implementation for collecting RA report without mixing the RA reports from two independent networks (PN and SNPN or two SNPN) in the same VarRA-Report is given below as changes to Clause 5.7.10.4 of 3GPP TS 38.331:

### 5.7.10.4 Actions Upon Successful Completion of a Random-Access Procedure or on Completion of a Request of On-Demand System Information

Upon successfully performing random-access procedure initialized with 4-step or 2-step RA type, or upon failed or successfully completed on-demand system information acquisition procedure in RRC_IDLE or RRC_INACTIVE state, the UE shall:
1> if the RPLMN or the PLMN selected by upper layers (see TS24.501 [23]) from the PLMN(s) included in the plmn-IdentityList in SIB1 is not included in plmn-IdentityList stored in a non-empty VarRA-Report:
   2> if the RPLMN or the PLMN selected by upper layers (see TS24.501 [23]) from the PLMN(s) included in the npn-IdentityInfoList in SIB1 is not included in npn-IdentityInfoList stored in a non-empty VarRA-Report:
   2> clear the information included in varRA-report;
1> if the number of RA-Report entries stored in the ra-ReportList in VarRA-Report is less than maxRAReport:
   2> if the number of PLMN entries in plmn-IdentityList and npn-IdentityInfoList stored in VarRA-Report is less than maxPLMN; or
   2> if the number of PLMN entries in plmn-IdentityList and npn-IdentityInfoList stored in VarRA-Report is equal to maxPLMN and the list of EPLMNs is subset of or equal to the plmn-IdentityList stored in VarRA-Report:
      3> append the following contents associated to the successfully completed random-access procedure or the failed or successfully completed on-demand system information acquisition procedure as a new entry in the VarRA-Report:
         4> if the list of EPLMNs has been stored by the UE:
5> set the plmn-IdentityList and npn-IdentityInfoList to include the list of EPLMNs stored by the UE (i.e. includes the RPLMN) without exceeding the limit of maxPLMN;
   4> else:
5> set the plmn-Identity, in plmn-IdentityList, to the PLMN selected by upper layers (see TS 24.501 [23]) from the PLMN(s) included in the plmn-IdentityInfoList in SIB1; or
5> set the npn-IdentityInfoList, in npn-IdentityInfoList, to the PLMN selected by upper layers (see TS24.501 [23]) from the PLMN(s) included in the npn-IdentityInfoList in SIB1;
   4> set the cellId to the global cell identity and the tracking area code, if available, otherwise to the physical cell identity and carrier frequency of the cell in which the corresponding random-access preamble was transmitted;
   4> if the corresponding random-access procedure was performed on an SCell of MCG:
5> set the spCellId to the global cell identity of the Pcell;
   4> if the corresponding random-access procedure was performed on an Scell of SCG:
5> set the spCellId to the global cell identity of the PSCell;
   4> set the raPurpose to include the purpose of triggering the random-access procedure;
   4> set the ra-InformationCommon as specified in clause 5.7.10.5.
      The UE may discard the random access report information, i.e. release the UE variable VarRA-Report, 48 hours after the last successful random access procedure or the failed or successfully completed on-demand system information acquisition procedure related information is added to the VarRA-Report.

NOTE 1: The UE does not log the RA information in the RA report if the triggering event of the random access is consistent UL LBT on SpCell as specified in TS38.321 [6].

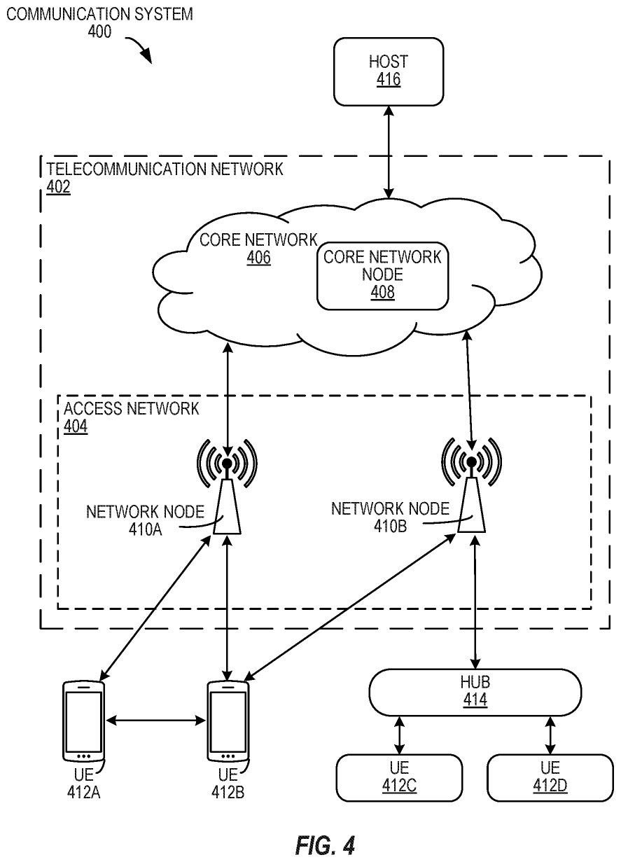

FIG. 4 shows an example of a communication system 400 in accordance with some embodiments.

In the example, the communication system 400 includes a telecommunication network 402 that includes an access network 404, such as a Radio Access Network (RAN), and a core network 406, which includes one or more core network nodes 408. The access network 404 includes one or more access network nodes, such as network nodes 410A and 410B (one or more of which may be generally referred to as network nodes 410), or any other similar Third Generation Partnership Project (3GPP) access node or non-3GPP Access Point (AP). The network nodes 410 facilitate direct or indirect connection of User Equipment (UE), such as by connecting UEs 412A, 412B, 412C, and 412D (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system 400 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 402 is a cellular network that implements 3GPP standardized features. Accordingly, the telecommunication network 402 may support network slicing to provide different logical networks to different devices that are connected to the telecommunication network 402. For example, the telecommunication network 402 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IOT) services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single-or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 414 communicates with the access network 404 to facilitate indirect communication between one or more UEs (e.g., UE 412C and/or 412D) and network nodes (e.g., network node 410B). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a Virtual Reality (VR) headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410B. The hub 414 may also allow for a different communication scheme and/or schedule between the hub 414 and UEs (e.g., UE 412C and/or 412D), and between the hub 414 and the core network 406. In other examples, the hub 414 is connected to the core network 406 and/or one or more UEs via a wired connection. Moreover, the hub 414 may be configured to connect to a Machine-to-Machine (M2M) service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub-that is, a hub whose primary function is to route communications to/from the UEs from/to the network node 410B. In other embodiments, the hub 414 may be a non-dedicated hub-that is, a device which is capable of operating to route communications between the UEs and the network node 410B, but which is additionally capable of operating as a communication start and/or end point for certain data channels.

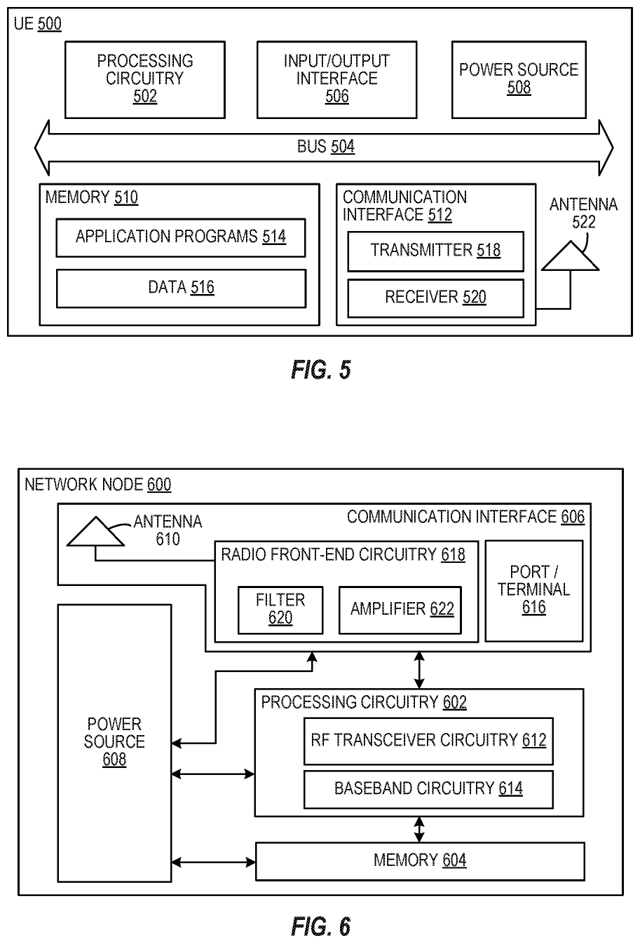

FIG. 5 shows a UE 500 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 502 may include multiple Central Processing Units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging the power source 508. Power circuitry may perform any formatting, converting, or other modification to the power from the power source 508 to make the power suitable for the respective components of the UE 500 to which power is supplied.

The memory 510 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 510 may allow the UE 500 to access instructions, application programs, and the like stored on transitory or non-transitory memory media, to off-load data, or to upload data. An article of manufacture, such as one utilizing a communication system, may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., the antenna 522) and may share circuit components, software, or firmware, or alternatively be implemented separately.

In the illustrated embodiment, communication functions of the communication interface 512 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 512, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on Its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 6 shows a network node 600 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, aPs (e.g., radio aPs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes processing circuitry 602, memory 604, a communication interface 606, and a power source 608. The network node 600 may be composed of multiple physically separate components (e.g., a Node B component and an RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 600 may be configured to support multiple RATs. In such embodiments, some components may be duplicated (e.g., separate memory 604 for different RATs) and some components may be reused (e.g., an antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 600.

The processing circuitry 602 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 600 components, such as the memory 604, to provide network node 600 functionality.

In some embodiments, the processing circuitry 602 includes a System on a Chip (SOC). In some embodiments, the processing circuitry 602 includes one or more of Radio Frequency (RF) transceiver circuitry 612 and baseband processing circuitry 614. In some embodiments, the RF transceiver circuitry 612 and the baseband processing circuitry 614 may be on separate chips (or sets of chips), boards, or units, such as radio units and digital units. In alternative embodiments, part or all of the RF transceiver circuitry 612 and the baseband processing circuitry 614 may be on the same chip or set of chips, boards, or units.

The memory 604 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and the memory 604 are integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. The radio front-end circuitry 618 comprises filters 620 and amplifiers 622. The radio front-end circuitry 618 may be connected to the antenna 610 and the processing circuitry 602. The radio front-end circuitry 618 may be configured to condition signals communicated between the antenna 610 and the processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of the filters 620 and/or the amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface 606 may comprise different components and/or different combinations of components.

In certain alternative embodiments, the network node 600 does not include separate radio front-end circuitry 618; instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes the one or more ports or terminals 616, the radio front-end circuitry 618, and the RF transceiver circuitry 612 as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, the communication interface 606, and/or the processing circuitry 602 may be configured to perform any receiving operations and/or certain obtaining operations described herein as being performed by the network node 600. Any information, data, and/or signals may be received from a UE, another network node, and/or any other network equipment. Similarly, the antenna 610, the communication interface 606, and/or the processing circuitry 602 may be configured to perform any transmitting operations described herein as being performed by the network node 600. Any information, data, and/or signals may be transmitted to a UE, another network node, and/or any other network equipment.

The power source 608 provides power to the various components of the network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid or an electricity outlet) via input circuitry or an interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

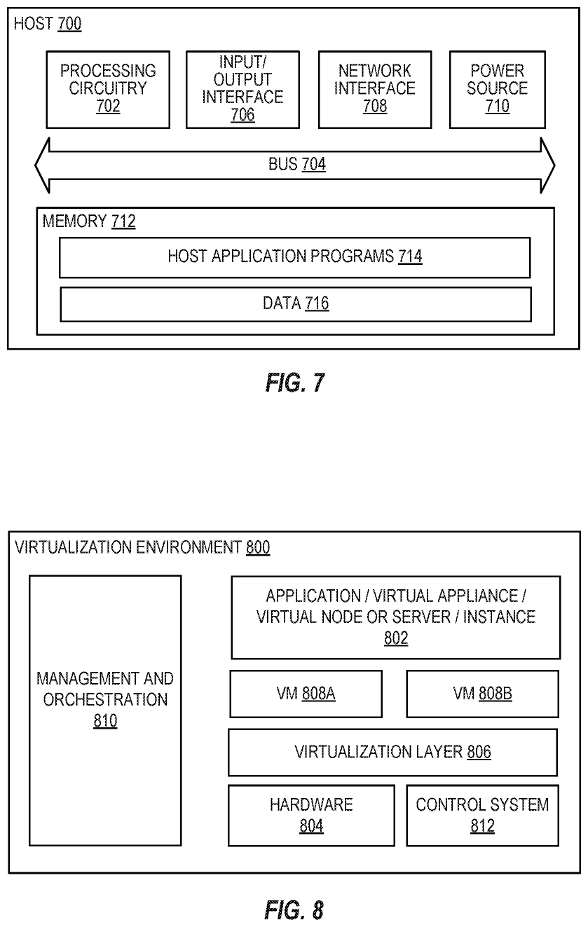

FIG. 7 is a block diagram of a host 700, which may be an embodiment of the host 416 of FIG. 4, in accordance with various aspects described herein. As used herein, the host 700 may be or comprise various combinations of hardware and/or software including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and memory 712. Other components may be included in other embodiments. Features of these components may be substantially similar to those described with respect to the devices of previous figures, such as FIGS. 5 and 6, such that the descriptions thereof are generally applicable to the corresponding components of the host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 714 may also provide for user authentication and licensing checks and may periodically report health, routes, and content availability to a central node, such as a device in or on the edge of a core network. Accordingly, the host 700 may select and/or indicate a different host for Over-The-Top (OTT) services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 8 is a block diagram illustrating a virtualization environment 800 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 802 (which may alternatively be called software instances, virtual appliances, network functions, virtual nodes, virtual network functions, etc.) are run in the virtualization environment 700 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or VM Monitors (VMMs)), provide VMs 808A and 808B (one or more of which may be generally referred to as VMs 808), and/or perform any of the functions, features, and/or benefits described in relation with some embodiments described herein. The virtualization layer 806 may present a virtual operating platform that appears like networking hardware to the VMs 808.

The VMs 808 comprise virtual processing, virtual memory, virtual networking, or interface and virtual storage, and may be run by a corresponding virtualization layer 806. Different embodiments of the instance of a virtual appliance 802 may be implemented on one or more of the VMs 808, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 808 may be a software implementation of a physical machine that runs programs as if they were executing on a physical, non-virtualized machine. Each of the VMs 808, and that part of the hardware 804 that executes that VM, be it hardware dedicated to that VM and/or hardware shared by that VM with others of the VMs 808, forms separate virtual network elements. Still in the context of NFV, a virtual network function is responsible for handling specific network functions that run in one or more VMs 808 on top of the hardware 804 and corresponds to the application 802.

The hardware 804 may be implemented in a standalone network node with generic or specific components. The hardware 804 may implement some functions via virtualization. Alternatively, the hardware 804 may be part of a larger cluster of hardware (e.g., such as in a data center or CPE) where many hardware nodes work together and are managed via management and orchestration 810, which, among others, oversees lifecycle management of the applications 802. In some embodiments, the hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 812 which may alternatively be used for communication between hardware nodes and radio units.

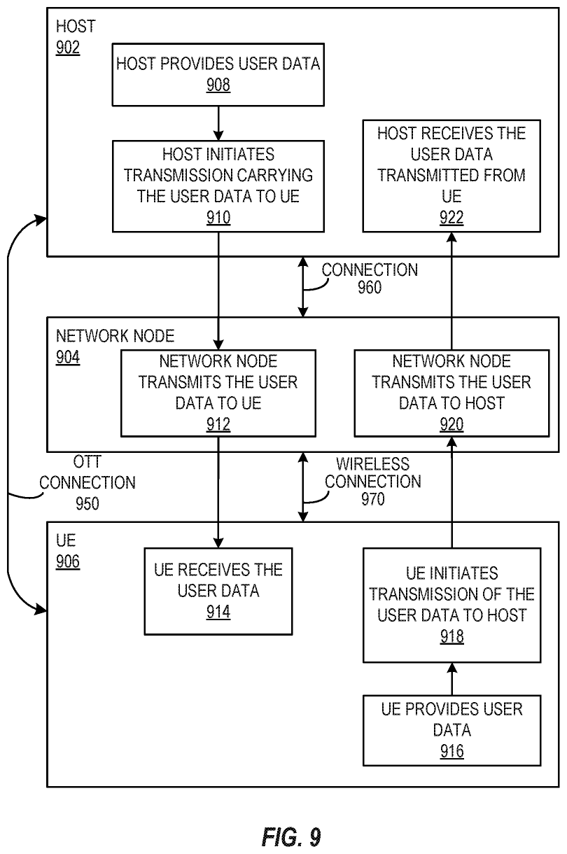

FIG. 9 shows a communication diagram of a host 902 communicating via a network node 904 with a UE 906 over a partially wireless connection in accordance with some embodiments. Example implementations, in accordance with various embodiments, of the UE (such as the UE 412A of FIG. 4 and/or the UE 500 of FIG. 5), the network node (such as the network node 410A of FIG. 4 and/or the network node 600 of FIG. 6), and the host (such as the host 416 of FIG. 4 and/or the host 700 of FIG. 7) discussed in the preceding paragraphs will now be described with reference to FIG. 9.

Like the host 700, embodiments of the host 902 include hardware, such as a communication interface, processing circuitry, and memory. The host 902 also includes software, which is stored in or is accessible by the host 902 and executable by the processing circuitry. The software includes a host application that may be operable to provide a service to a remote user, such as the UE 906 connecting via an OTT connection 950 extending between the UE 906 and the host 902. In providing the service to the remote user, a host application may provide user data which is transmitted using the OTT connection 950.

The network node 904 includes hardware enabling it to communicate with the host 902 and the UE 906 via a connection 960. The connection 960 may be direct or pass through a core network (like the core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by the UE 906 and executable by the UE's processing circuitry. The software includes a client application, such as a web browser or operator-specific “app” that may be operable to provide a service to a human or non-human user via the UE 906 with the support of the host 902. In the host 902, an executing host application may communicate with the executing client application via the OTT connection 950 terminating at the UE 906 and the host 902. In providing the service to the user, the U's client application may receive request data from the host application and provide user data in response to the request data. The OTT connection 950 may transfer both the request data and the user data. The U″s client application may interact with the user to generate the user data that it provides to the host application through the OTT connection 950.

The OTT connection 950 may extend via the connection 960 between the host 902 and the network node 904 and via a wireless connection 970 between the network node 904 and the UE 906 to provide the connection between the host 902 and the UE 906. The connection 960 and the wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904 in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR, or AR which it can broadcast, multicast, or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 950 between the host 902 and the UE 906 in response to variations in the measurement results. The measurement procedure and/or the network functionality for reconfiguring the OTT connection 950 may be implemented in software and hardware of the host 902 and/or the UE 906. In some embodiments, sensors (not shown) may be deployed in or in association with other devices through which the OTT connection 950 passes; the sensors may participate in the measurement procedure by supplying values of the monitored quantities exemplified above, or by supplying values of other physical quantities from which software may compute or estimate the monitored quantities. The reconfiguring of the OTT connection 950 may include message format, retransmission settings, preferred routing, etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency, and the like by the host 902. The measurements may be implemented in that software causes messages to be transmitted, in particular empty or ‘dummy’ messages, using the OTT connection 950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### Group A Embodiments

Embodiment 1: A method performed by a user equipment, UE, the method comprising: connecting or registering (300) to a first network; while connected or registered to the first network, storing (300) SON/MDT measurements and information (e.g., in one or more UE variables); connecting or registering (302) to a second network; disconnecting or deregistering (302) from the first network while having un-fetched SON/MDT measurements and information for the first network stored in the UE; performing (304) one or more actions to ensure that the un-fetched SON/MDT measurements and information for the first network are not mixed with SON/MDT measurements and information for the second network (e.g., stored in the same one or more UE variables).

Embodiment 2: The method of embodiment 1, wherein the first network and the second network are independent networks.

Embodiment 3: The method of embodiment 1, wherein the first network is a public network, and the second network is a Non-Public Network, NPN (e.g., a SNPN or PNI-NPN).

Embodiment 4: The method of any of embodiments 1 to 3, wherein performing (304) the one or more actions to ensure that the un-fetched SON/MDT measurements and information for the first network are not mixed with SON/MDT measurements and information for the second network comprises performing (304) the one or more actions to ensure that the un-fetched SON/MDT measurements and information for the first network are not mixed with SON/MDT measurements and information for the second network even if the first network and the second network have a same Public Land Mobile Network, PLMN, Identity, ID.

Embodiment 5: The method of any of embodiments 1 to 4, wherein performing the one or more actions to ensure that the un-fetched SON/MDT measurements and information for the first network are not mixed with SON/MDT measurements and information for the second network comprises: determining (304A-1; 304B-1) that a network identity (e.g., NPN identifier) of the second network is different than a network identity (e.g., PLMN ID or PLMN ID+NPN ID such as NID or CAG ID) of the first network; and, in response thereto, deleting (304A-2; 304B-2) the un-fetched SON/MDT measurements and information for the first network (e.g., from a UE variable(s)) and storing (304A-3; 304B-3) new SON/MDT measurements and information for the second network (e.g., in the same UE variable(s)).

Embodiment 6: The method of embodiment 5, wherein determining (304A-1; 304B-1) that the network identity of the second network is different than the network identity of the first network comprises determining (304A-1; 304B-1) that the network identity of the second network is different than the network identity in response to either logging a SON/MDT report that pertains to the second network or registering to the second network.

Embodiment 7: The method of any of embodiments 1 to 4, wherein performing (304) the one or more actions to ensure that the un-fetched SON/MDT measurements and information for the first network are not mixed with SON/MDT measurements and information for the second network comprises: storing (304C-1) SON/MDT measurements and information for the second network in association with a network identity (e.g., NPD ID or SNPN ID) of the second network.

Embodiment 8: The method of any of embodiments 1 to 7, further comprising sending, to a network node in the second network, a report(s) comprising SONMDT measurements and information for the second network.

Embodiment 9: The method of any of the previous embodiments, further comprising: providing user data; and forwarding the user data to a host via the transmission to the network node.

### Group B Embodiments

Embodiment 10: A user equipment, UE, comprising: processing circuitry configured to perform any of the steps of any of the Group A embodiments; and power supply circuitry configured to supply power to the processing circuitry.

Embodiment 11: A user equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 12: A host configured to operate in a communication system to provide an over-the-top, OTT, service, the host comprising: processing circuitry configured to provide user data; and a network interface configured to initiate transmission of the user data to a cellular network for transmission to a user equipment, UE; wherein the UE comprises a communication interface and processing circuitry, the communication interface and processing circuitry of the UE being configured to perform any of the steps of any of the Group A embodiments to receive the user data from the host.

Embodiment 13: The host of the previous embodiment, wherein the cellular network further includes a network node configured to communicate with the UE to transmit the user data to the UE from the host.

Embodiment 14: The host of the previous 2 embodiments, wherein: the processing circuitry of the host is configured to execute a host application, thereby providing the user data; and the host application is configured to interact with a client application executing on the UE, the client application being associated with the host application.

Embodiment 15: A method implemented by a host operating in a communication system that further includes a network node and a user equipment, UE, the method comprising: providing user data for the UE; and initiating a transmission carrying the user data to the UE via a cellular network comprising the network node, wherein the UE performs any of the operations of any of the Group A embodiments to receive the user data from the host.

Embodiment 16: The method of the previous embodiment, further comprising: at the host, executing a host application associated with a client application executing on the UE to receive the user data from the UE.

Embodiment 17: The method of the previous embodiment, further comprising: at the host, transmitting input data to the client application executing on the UE, the input data being provided by executing the host application, wherein the user data is provided by the client application in response to the input data from the host application.

Embodiment 18: A host configured to operate in a communication system to provide an over-the-top (OTT) service, the host comprising: processing circuitry configured to provide user data; and a network interface configured to initiate transmission of the user data to a cellular network for transmission to a user equipment, UE; wherein the UE comprises a communication interface and processing circuitry, the communication interface and processing circuitry of the UE being configured to perform any of the steps of any of the Group A embodiments to transmit the user data to the host.

Embodiment 19: The host of the previous embodiment, wherein the cellular network further includes a network node configured to communicate with the UE to transmit the user data from the UE to the host.

Embodiment 20: The host of the previous 2 embodiments, wherein: the processing circuitry of the host is configured to execute a host application, thereby providing the user data; and the host application is configured to interact with a client application executing on the UE, the client application being associated with the host application.

Embodiment 21: A method implemented by a host configured to operate in a communication system that further includes a network node and a user equipment, UE, the method comprising: at the host, receiving user data transmitted to the host via the network node by the UE, wherein the UE performs any of the steps of any of the Group A embodiments to transmit the user data to the host.

Embodiment 22: The method of the previous embodiment, further comprising: at the host, executing a host application associated with a client application executing on the UE to receive the user data from the UE.

Embodiment 23: The method of the previous embodiment, further comprising: at the host, transmitting input data to the client application executing on the UE, the input data being provided by executing the host application, wherein the user data is provided by the client application in response to the input data from the host application.

Those skilled in the art will recognize improvements and modifications to the embodiments of the present disclosure. All such improvements and modifications are considered within the scope of the concepts disclosed herein.

1-21. (canceled)

22. A method performed by a User Equipment (UE), the method comprising:
performing one or more actions to ensure that un-fetched Self-Organizing Network/Minimization of Drive Testing (SON/MDT) measurements associated with a first network from which the UE has disconnected or deregistered are not mixed with SON/MDT measurements associated with a second network to which the UE has connected or registered, wherein the one or more actions comprise:
in response to determining that a network identity of the second network is different than a network identity of the first network:
deleting the un-fetched SON/MDT measurements associated with the first network from a non-empty UE variable; and
storing the SON/MDT measurements associated with the second network in an empty UE variable.

23. The method of claim 22, wherein the non-empty UE variable corresponds to a non-empty VarRA-Report and the empty UE variable corresponds to an empty VarRA-Report.

24. The method of claim 22, wherein a same UE variable is used as the non-empty UE variable from which the un-fetched SON/MDT measurements associated with the first network are deleted, thereby emptying said same UE variable, and as the empty UE variable to which the SON/MDT measurements associated with the second network are stored.

25. The method of claim 22, wherein the first network and the second network are independent networks.

26. The method of claim 22, wherein the first network is a public network and the second network is a Non-Public Network (NPN).

27. The method of claim 22, wherein the second network is a Standalone Non-Public Network (SNPN).

28. The method of claim 22, wherein the network identity of the second network comprises a Non-Public Network (NPN) identifier or a Standalone Non-Public Network (SNPN) identifier, and wherein determining that that the network identity of the second network is different than the network identity of the first network is based on the NPN identifier or the SNPN identifier of the second network.

29. The method of claim 22, wherein the first network and the second network have a same Public Land Mobile Network (PLMN) identity.

30. The method of claim 22, wherein the network identity of the second network comprises a Non-Public Network (NPN) identifier and the network identity of the first network comprises a Public Land Mobile Network (PLMN) or the PLMN identifier combined with an NPN identifier of the first network.

31. The method of claim 22, wherein the method initiates the determining that the network identity of the second network is different than the network identity of the first network in response to logging a SON/MDT report that pertains to the second network or in response to registering the UE to the second network.

32. The method of claim 22, wherein storing the SON/MDT measurements associated with the second network comprises storing the SON/MDT measurements associated with the second network in association with the network identity of the second network.

33. The method of claim 22, further comprising sending, to a network node in the second network, a report comprising the SON/MDT measurements associated with the second network.

34. A User Equipment (UE), the UE comprising:
a communication interface; and
processing circuitry associated with the communication interface, the processing circuitry configured to cause the UE to perform one or more actions to ensure that un-fetched Self-Organizing Network/Minimization of Drive Testing (SON/MDT) measurements associated with a first network from which the UE has disconnected or deregistered are not mixed with SON/MDT measurements associated with a second network to which the UE has connected or registered, wherein the one or more actions comprise:
in response to determining that a network identity of the second network is different than a network identity of the first network:
deleting the un-fetched SON/MDT measurements associated with the first network from a non-empty UE variable; and
storing the SON/MDT measurements associated with the second network in an empty UE variable.

35. The UE of claim 34, wherein the non-empty UE variable corresponds to a non-empty VarRA-Report and the empty UE variable corresponds to an empty VarRA-Report.

36. The UE of claim 34, wherein a same UE variable is used as the non-empty UE variable from which the un-fetched SON/MDT measurements associated with the first network are deleted, thereby emptying said same UE variable, and as the empty UE variable to which the SON/MDT measurements associated with the second network are stored.

37. The UE of claim 34, wherein the first network and the second network are independent networks, the first network and the second network having a same Public Land Mobile Network (PLMN) identity, the network identity of the second network comprising a Non-Public Network (NPN) identifier or a Standalone Non-Public Network (SNPN) identifier different than the network identity of the first network.

38. The UE of claim 34, wherein the network identity of the second network comprises a Non-Public Network (NPN) identifier or a Standalone Non-Public Network (SNPN) identifier, and wherein the processing circuitry is configured to determine that that the network identity of the second network is different than the network identity of the first network based on the NPN identifier or the SNPN identifier of the second network.

39. The UE of claim 34, wherein the network identity of the second network comprises a Non-Public Network (NPN) identifier and the network identity of the first network comprises a Public Land Mobile Network (PLMN) or the PLMN identifier combined with an NPN identifier of the first network.

40. The UE of claim 34, the processing circuitry further configured to perform at least one of:
initiate the determining that the network identity of the second network is different than the network identity of the first network in response to logging a SON/MDT report that pertains to the second network or in response to registering the UE to the second network;
store the SON/MDT measurements associated with the second network in association with the network identity of the second network; and
send, to a network node in the second network, a report comprising the SON/MDT measurements associated with the second network.

41. A non-transitory computer readable medium comprising instructions executable by processing circuitry of a User Equipment, UE, wherein the UE is operable to:
perform one or more actions to ensure that un-fetched Self-Organizing Network/Minimization of Drive Testing (SON/MDT) measurements associated with a first network from which the UE has disconnected or deregistered are not mixed with SON/MDT measurements associated with a second network to which the UE has connected or registered, wherein the one or more actions comprise, in response to determining that a network identity of the second network is different than a network identity of the first network:
deleting the un-fetched SON/MDT measurements associated with the first network from a non-empty UE variable; and
storing the SON/MDT measurements associated with the second network in an empty UE variable.
